(19) United States
(12) Patent Application Publication
(10) Pub. No.: US 2026/0095548 A1
(43) Pub. Date: Apr. 2, 2026

(54) PROVIDING DATA TO ADDITIONAL DEVICES IN A VIRTUAL MEETING

(71) Applicant: Google LLC, Mountain View, CA (US)

(72) Inventors: Kathleen Alexandra Bryan, New York, NY (US); Shiblee Imtiaz Hasan, Santa Clara, CA (US)

(21) Appl. No.: 18/903,550

(22) Filed: Oct. 1, 2024

(51) Int. Cl. H04N 7/15

(52) U.S. Cl. CPC H04N 7/157; H04N 7/152

(57) ABSTRACT

A method for providing data to additional devices in a virtual meeting includes causing a virtual meeting UI, including one or more regions each corresponding to respective media streams generated by a client device, to be presented during a virtual meeting. The method includes obtaining an indication that a first additional device associated with a first client device of a first participant of the plurality of participants is available at a location of the first participant. The method includes causing the virtual meeting UI to be modified to present, in a first region corresponding to a first media stream generated by the first client device, a visual indication of the first additional device. The method includes causing first data indicated by a second client device to be sent to the first additional device to cause the first additional device to perform a first predetermined action.

### TECHNICAL FIELD

Aspects and implementations of the present disclosure relate to virtual meetings and more specifically to providing data to additional devices in a virtual meeting.

### BACKGROUND

Virtual meetings can take place between multiple participants via a virtual meeting platform. A virtual meeting platform can include tools that allow multiple client devices to be connected over a network and share each other's audio (e.g., voice of a user recorded via a microphone of a client device) and/or video stream (e.g., a video captured by a camera of a client device, or video captured from a screen image of the client device) for efficient communication. To this end, the virtual meeting platform can provide a user interface that includes multiple regions to present the video stream of each participating client device.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

An aspect of the disclosure provides a method for providing data to additional devices in a virtual meeting. The method includes causing a virtual meeting user interface (UI) to be presented during a virtual meeting between one or more participants. The virtual meeting UI may include one or more regions. Each region may correspond to a media stream generated by a client device of a participant of the one or more participants. The method includes obtaining an indication that a first additional device associated with a first client device of a first participant of the one or more participants is available at a location of the first participant. The method includes causing the virtual meeting UI to be modified to present, in a first region corresponding to a first media stream generated by the first client device, a visual indication of the first additional device. The method includes causing first data indicated by a second client device of a second participant of the one or more participants to be sent to the first additional device to cause the first additional device to perform a first predetermined action.

Another aspect of the disclosure provides a system. The system includes a memory and a processing device coupled to the memory. The processing device is configured to perform one or more operations. The operations include causing a virtual meeting UI to be presented during a virtual meeting between one or more participants. The virtual meeting UI may include one or more regions. Each region may correspond to a media stream generated by a client device of a participant of the one or more participants. The operations include obtaining an indication that a first additional device associated with a first client device of a first participant of the one or more participants is available at a location of the first participant. The operations include causing the virtual meeting UI to be modified to present, in a first region corresponding to a first media stream generated by the first client device, a visual indication of the first additional device. The operations include causing first data indicated by a second client device of a second participant of the one or more participants to be sent to the first additional device to cause the first additional device to perform a first predetermined action.

Another aspect of the disclosure provides a non-transitory computer-readable storage medium with instructions that, when executed by a processing device, cause the processing device to perform operations. The operations include causing a virtual meeting UI to be presented during a virtual meeting between one or more participants. The virtual meeting UI may include one or more regions. Each region may correspond to a media stream generated by a client device of a participant of the one or more participants. The operations include obtaining an indication that a first additional device associated with a first client device of a first participant of the one or more participants is available at a location of the first participant. The operations include causing the virtual meeting UI to be modified to present, in a first region corresponding to a first media stream generated by the first client device, a visual indication of the first additional device. The operations include causing first data indicated by a second client device of a second participant of the one or more participants to be sent to the first additional device to cause the first additional device to perform a first predetermined action.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture for providing data to additional devices in a virtual meeting, in accordance with some implementations of the present disclosure.

FIG. 2 illustrates a schematic block diagram for an artificial intelligence (AI) training subsystem of a virtual meeting platform, in accordance with some implementations of the present disclosure.

FIG. 3 illustrates a schematic block diagram for an AI inference subsystem of a virtual meeting platform, in accordance with some implementations of the present disclosure.

FIG. 4 depicts a flow diagram of a method for providing data to additional devices in a virtual meeting, in accordance with some implementations of the present disclosure.

FIG. 5 depicts a virtual meeting user interface (UI) for providing data to additional devices in a virtual meeting, in accordance with some implementations of the present disclosure.

FIG. 6 depicts a virtual meeting UI for providing data to additional devices in a virtual meeting, in accordance with some implementations of the present disclosure.

FIG. 7 depicts a virtual meeting UI for providing data to additional devices in a virtual meeting, in accordance with some implementations of the present disclosure.

FIG. 8 is a block diagram illustrating an example computer system, in accordance with some implementations of the present disclosure.

### DETAILED DESCRIPTION

Aspects of the present disclosure relate to providing data to additional devices in a virtual meeting. A virtual meeting platform can enable video-based conferences between multiple participants via respective client devices that are connected over a network and share each other's audio (e.g., voice of a user recorded via a microphone of a client device) and/or video streams (e.g., a video captured by a camera of a client device) during a virtual meeting. In some instances, a virtual meeting platform can enable a significant number of client devices (e.g., up to one hundred or more client devices) to be connected via the virtual meeting. A participant of a virtual meeting can speak to the other participants of the virtual meeting. Some existing virtual meeting platforms can provide a user interface (UI) to each client device connected to the virtual meeting, where the UI displays visual items corresponding to the video streams shared over the network in a set of regions in the UI.

In addition to using a client device to participate in a virtual meeting, a virtual meeting participant can use an additional device that can perform actions during a virtual meeting. An additional device can include a device such as a printer, a mobile device, or a virtual reality (VR) headset. Other virtual meeting participants can provide data designated for the additional device. For example, during a virtual meeting, a first participant can send data to a second participant so the second participant can use the data with the additional device. For example, the first participant can send a text document to the second participant so the second participant can use a printer to print the text document.

Typically, the first participant sends an email to the second participant with the data attached to the email, or the first participant sends a link to the data to the second participant via a chat interface of the virtual meeting. The second participant can then download the data to the second participant's client device and then use the client device to send the data to the additional device. This presents several disadvantages. The process of the first participant sending the data to the second participant, the second participant downloading the data to the second participant's client device, and the second participant sending the data from the client device to the additional device requires a series of actions that distracts the participants from otherwise participating in the virtual meeting. Also, if the first participant makes the data available to the second participant via a link, the second participant should have access to the location where the data is stored (e.g., the second participant should have an account on a cloud storage platform where the data is stored).

Implementations of the present disclosure address the above and other deficiencies by providing data-sharing operations for additional devices during a virtual meeting. A first participant can provide, to a virtual meeting system, an indication that identifies one or more additional devices at the location of the first participant. The indication can specify that the one or more additional devices are available to perform actions during a virtual meeting. For example, an additional device may include a printer, and an available action for the printer may include printing a document. During a virtual meeting, the virtual meeting system can modify a virtual meeting UI displayed on a second participant's client device. Modifying the virtual meeting UI can cause the UI to present a visual indication that indicates the availability of the first participant's one or more additional devices. For example, a region of the virtual meeting UI that corresponds to the first participant's video stream can display an outline around the first participant's printer that is visible in the UI region corresponding to first participant's video stream. The second participant can interact with the visual indication, and the virtual meeting UI can display options for one or more actions available to the second participant regarding the first participant's additional device. For example, the virtual meeting UI can display an option for the second participant to provide a file to be printed by the first participant's printer. The virtual meeting system can cause data (e.g., the file to be printed) to be sent to the first participant's additional device so the additional device can perform the selected action, without the second participant's needing to use another system or application (e.g., a cloud-based storage service, a messaging application, etc.) and without the second participant's needing to download the requested content.

Aspects of the present disclosure provide technical advantages over previous solutions. Aspects of the present disclosure provide an automated and streamlined process for providing data indicated by a first virtual meeting participant's client device to an additional device of another virtual meeting participant so the additional device can perform an operation selected by the first participant. Thus, the additional device is able to perform the selected action faster and more efficiently than in conventional virtual meeting systems, and the experience of the virtual meeting participants is enhanced.

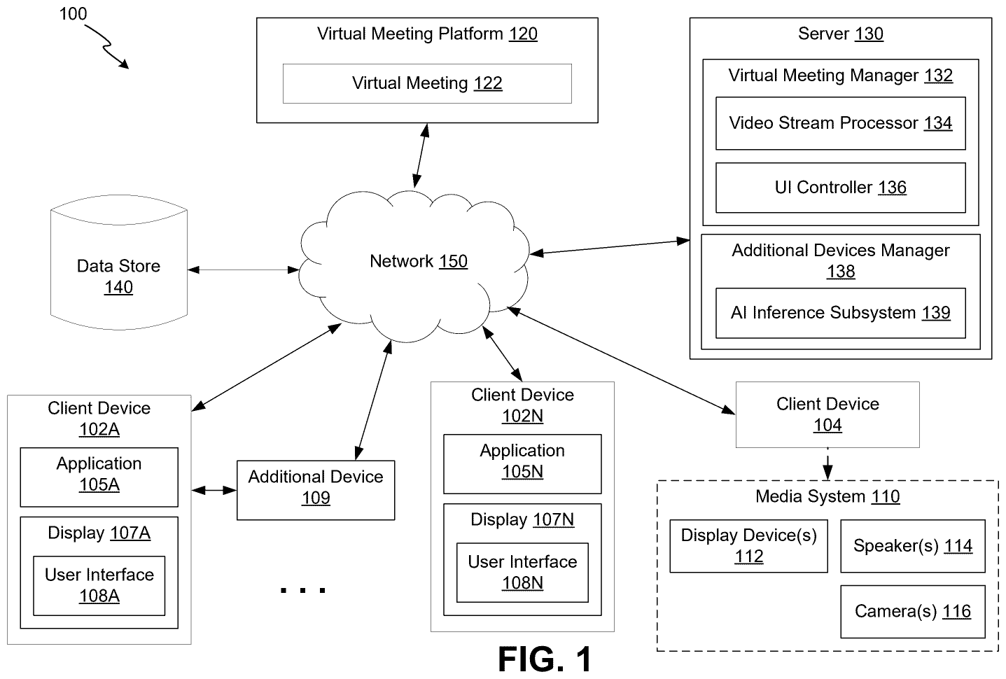

FIG. 1 illustrates an example system architecture 100, in accordance with implementations of the present disclosure. The system architecture 100 includes one or more client devices 102A-N or 104, a virtual meeting platform 120, a server 130, and a data store 140, each connected to a network 150.

In some implementations, the virtual meeting platform 120 enables users of one or more of the client devices 102A-N, 104 to connect with each other in a virtual meeting (e.g., a virtual meeting 122). A virtual meeting 122 refers to a real-time communication session such as a video-based call or video chat, in which participants can connect with multiple additional participants in real-time and be provided with audio and video capabilities. A virtual meeting 122 may include an audio-based call or chat, in which participants connect with multiple additional participants in real-time and are provided with audio capabilities. Real-time communication refers to the ability for users to communicate (e.g., exchange information) instantly without transmission delays and/or with negligible (e.g., milliseconds or microseconds) latency. The virtual meeting platform 120 can allow a user of the virtual meeting platform 120 to join and participate in a virtual meeting 122 with other users of the virtual meeting platform 120 (such users sometimes being referred to, herein, as “virtual meeting participants” or, simply, “participants”). Implementations of the present disclosure can be implemented with any number of participants connecting via the virtual meeting 122 (e.g., up to one hundred or more).

In implementations of the disclosure, a “user” or “participant” can be represented as a single individual. However, other implementations of the disclosure encompass a “user” being an entity controlled by a set of users or an organization and/or an automated source such as a system or a platform. In situations in which the systems discussed here collect personal information about users, or can make use of personal information, the users can be provided with an opportunity to control whether the virtual meeting platform 120 or the virtual meeting manager 132 collects user information (e.g., information about a user's social network, social actions or activities, profession, a user's preferences, or a user's current location), or to control whether or how to receive content from the virtual meeting platform 120 or the virtual meeting manager 132 that can be more relevant to the user. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over how information is collected about the user and used by the virtual meeting platform 120 or the virtual meeting manager 132.

In some implementations, the server 130 includes a virtual meeting manager 132. The virtual meeting manager 132, in one or more implementations, is configured to manage a virtual meeting 122 between multiple users of the virtual meeting platform 120. The virtual meeting manager 132 can provide the UIs 108A-N to each client device 102A-N, 104 to enable users to watch and listen to each other during a virtual meeting 122. The virtual meeting manager 132 can also collect and provide data associated with the virtual meeting 122 to each participant of the virtual meeting 122. In some implementations, the virtual meeting manager 132 provides the UIs 108A-N for presentation by client applications 105A-N. For example, the respective UIs 108A-N can be displayed on the display devices 107A-N by the client applications 105A-N executing on the operating systems of the client devices 102A-N, 104. In some implementations, the virtual meeting manager 132 determines visual items for presentation in the UIs 108A-N during a virtual meeting. A visual item can refer to a UI element that occupies a particular region in the UI and is dedicated to presenting a video stream from a respective client device. Such a video stream can depict, for example, a user of the respective client device 102A-N, 104 while the user is participating in the virtual meeting 122 (e.g., speaking, presenting, listening to other participants, watching other participants, etc., at particular moments during the virtual meeting 122), a physical conference or meeting room (e.g., with one or more participants present), a document or media content (e.g., video content, one or more images, etc.) being presented during the virtual meeting 122, etc.

In some implementations, the virtual meeting manager 132 includes a video stream processor 134 and a UI controller 136. Each of the video stream processor 134 or the UI controller 136 may include a software application (or a subset thereof) that performs certain virtual meeting functionality for the virtual meeting manager 132. The video stream processor 134 may be configured to receive video streams from one or more of the client devices 102A-N, 104. The video stream processor 134 may be configured to determine visual items for presentation in the UI of such client devices 102A-N, 104 (e.g., the UIs 108-108N, discussed below) during the virtual meeting 122. Each visual item can correspond to a video stream from a client device 102A-N, 104 (e.g., the video stream pertaining to one or more participants of the virtual meeting 122). In some implementations, the video stream processor 134 receives audio streams associated with the video streams from the client devices (e.g., from an audiovisual component of the client devices 102A-N, 104). Once the video stream processor 134 has determined visual items for presentation in the UI, the video stream processor 134 can notify the UI controller 136 of the determined visual items. The visual items for presentation can be determined based on current speaker, current presenter, order of the participants joining the virtual meeting 122, list of participants (e.g., alphabetical), etc.

In some implementations, the UI controller 136 provides the UI for the virtual meeting 122 (e.g., the UI 108A-N). The UI can include multiple regions. Each region can display a video stream pertaining to one or more participants of the virtual meeting 122. The UI controller 136 can control which video stream is to be displayed by providing a command to one or more client devices 102A-N, 104 that indicates which video stream is to be displayed in which region of the UI (along with the received video and audio streams being provided to the client devices 102A-N, 104). For example, in response to being notified of the determined visual items for presentation in the UI 108A-N, the UI controller 136 can transmit a command causing each determined visual item to be displayed in a region of the UI and/or rearranged in the UI.

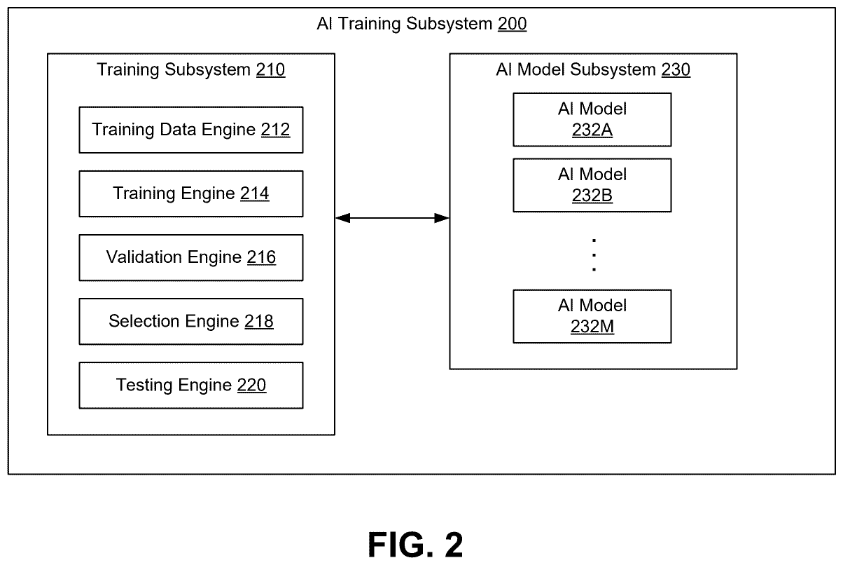

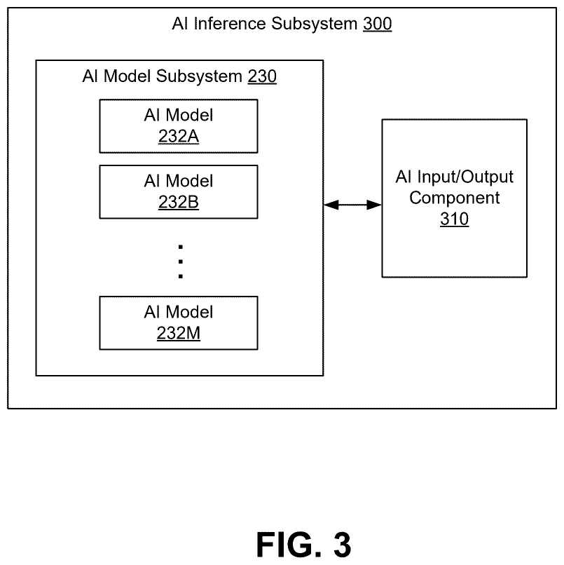

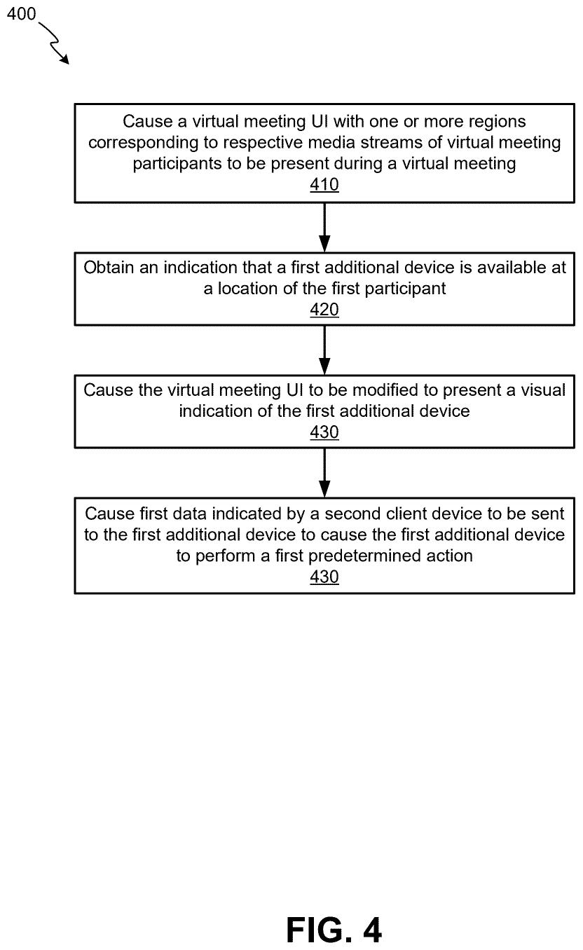

In one or more implementations, the virtual meeting manager 132 includes an additional devices manager 138. The additional devices manager 138 may include a software application (or a subset thereof) that performs certain virtual meeting functionality for the virtual meeting manager 132. The additional devices manager 138 may be configured to obtain an indication from a client device 102A-N, 104 that an additional device 109 associated with the client device 102A-N, 104 is available to virtual meeting participants to perform certain actions during the virtual meeting 122, modify a virtual meeting UI 108A-N to visually indicate the availability of the additional device 109, and cause the additional device 109 to receive data to cause the additional device to perform an action. The additional devices manager 138 may include an AI inference subsystem 139. The AI inference subsystem 139 may include one or more AI models configured to identify an additional device 109. The additional devices manager 138 may use the AI inference subsystem 139 to identify an additional device 109 that the participant associated with the additional device 109 has not indicated as available. Some aspects of the functionality of the additional devices manager 138 are discussed further below in relation to FIG. 4. Some aspects of the functionality of the AI inference subsystem 139 are discussed further below in relation to FIGS. 2-3.

In some implementations, each of the virtual meeting platform 120 or the server 130 include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that can be used to enable a user to connect with other users via a virtual meeting 122. The virtual meeting platform 120 can also include a website (e.g., one or more webpages) or application back-end software that can be used to enable a user to connect with other users by way of the virtual meeting 122.

In some implementations, the one or more client devices 102A-N each include one or more computing devices such as personal computers (PCs), laptops, mobile phones, smart phones, tablet computers, netbook computers, network-connected televisions, etc. The one or more client devices 102A-N can also be referred to as “user devices.” Each client device 102A-N can include an audiovisual component that can generate audio and video data to be streamed to the virtual meeting manager 132. The audiovisual component can include a device (e.g., a microphone) to capture an audio signal representing speech of a user and generate audio data (e.g., an audio file or audio stream) based on the captured audio signal. The audiovisual component can include another device (e.g., a speaker) to output audio data to a user associated with a particular client device 102A-N. In some implementations, the audiovisual component includes an image capture device (e.g., a camera) to capture images and generate video data (e.g., a video stream) of the captured data of the captured images.

In some implementations, the system architecture 100 includes a client device 104. The client device 104 can differ from a client device of the one or more client devices 102A-N because the client device 104 may be associated with a physical conference or meeting room. Such client device 104 can include or be coupled to a media system 110 that can include one or more display devices 112, one or more speakers 114 and one or more cameras 116. The display device 112 can be, for example, a smart display or a non-smart display (e.g., a display that is not itself configured to connect to the network 150). Users that are physically present in the room can use the media system 110 rather than their own devices (e.g., one or more of the client devices 102A-N) to participate in the virtual meeting 122, which can include other remote users. For example, the users in the room that participate in the virtual meeting 122 can control the display device 112 to show a slide presentation or watch slide presentations of other participants. Sound and/or camera control can similarly be performed. Similar to client devices 102A-N, the one or more client devices 104 can generate audio and video data to be streamed to the virtual meeting manager 132 (e.g., using one or more microphones, speakers 114 and cameras 116).

As described previously, an audiovisual component of each client device 102A-N, 104 can capture images and generate video data (e.g., a video stream) of the captured data of the captured images. In some implementations, the client devices 102A-N, 104 transmit the generated video stream to virtual meeting manager 132. The audiovisual component of each client device 102A-N, 104 can also capture an audio signal representing speech of a user and generate audio data (e.g., an audio file or audio stream) based on the captured audio signal. In some implementations, the client devices 102A-N, 104 transmit the generated audio data to the virtual meeting manager 132.

In some implementations, each client device 102A-N or 104 includes a respective client application 105A-N, which can be a mobile application, a desktop application, a web browser, etc. The client application 105A-N can present, on a display device 107A-N of a client device 102A-N or a UI (e.g., a UI of the UIs 108A-N), one or more features of the application 105A-N for users to access the virtual meeting platform 120. For example, a user of a first client device 102A can join and participate in the virtual meeting 122 via a UI 108A presented on the display device 107A by the application 105A. The user can present a document to participants of the virtual meeting 122 using the virtual meeting UI 108A. Each of the virtual meeting UIs 108A-N can include multiple regions to present visual items corresponding to video streams of the client devices 102A-N provided to the server 130 for the virtual meeting 122.

In one implementation, the system architecture 100 includes an additional device 109. The additional device 109 may include a device located in an area near a client device 102A-N, 104 or a device connected to a client device 102A-N, 104. For example, the additional device 109 may include a device in an area that is visible in a video stream produced by the client device 102A-N, 104 or a device that is otherwise associated with the client device 102A-N, 104 due its proximity (e.g., being in the same room or in the same building) or its connection with the client device 102A-N, 104, even though it may not visible in the video stream produced by the client device 102A-N, 104. The additional device 109 can be configured to perform one or more predetermined actions.

As an example, an additional device 109 may include a printer. A printer may include a device that receives data to print (e.g., a word processing file, a portable document format (PDF) file, etc.) and prints a durable representation of text or graphics on paper based on the data. The printer may include a multi-function printer configured to perform actions in addition to printing (e.g., scanning, transmitting a facsimile (fax), photocopying, etc.). Predetermined actions of the printer may include printing, scanning, transmitting a fax, or photocopying.

In another example, the additional device 109 may include a virtual reality (VR) headset. A VR headset may include a head-mounted device that uses one or more near-eye displays to provide a VR environment to a user. Predetermined actions of the VR headset may include displaying two-dimensional (2D) or three-dimensional (3D) visualizations based on data accessible by the VR headset, executing VR software or a VR application, or performing other VR operations.

In another example, the additional device 109 may include a mobile device. A mobile device may include a mobile computing device, which may include a smartphone, a tablet computer, a smartwatch, or other mobile computing devices. Predetermined actions of a mobile device may include presenting an image, video, or visual representation of a file; playing audio data; executing a mobile application or other software; or other mobile device functionality.

Another example of an additional device 109 may include a lighting device. A lighting device may include a lighting system that includes light bulbs, sensors, adapters, and/or transmitters and is configured to provide light and be controlled over a network. The lighting device may include an Internet-of-Things (IoT) device connected to the network 150. Predetermined actions of a lighting device may include activating or deactivating a lightbulb, changing the color of the light provided by a lightbulb, activating one or more lightbulbs to present a lighting pattern, or other lighting actions.

Another example of an additional device 109 may include an audio speaker. The audio speaker may include a device configured to produce audio based on received audio signals or data. An audio speaker may include a smart speaker, which may include an audio speaker with a microphone that performs voice command operations using an integrated virtual assistant. The audio speaker may be an IoT device. Predetermined actions of an audio speaker may include activating or deactivating the speaker, playing audio data, increasing or decreasing a volume of the audio speaker, performing virtual assistant operations, or other audio speaker operations.

One example of an additional device 109 may include a thermostat. A thermostat may include a device that controls a building's (or a portion of a building's) heating, ventilation, or air conditioning (HVAC). The thermostat may include a smart thermostat that is connected to the network 150, may be an IoT device, and may receive data (weather data) from the network in order to adjust the smart thermostat's configurations. Predetermined actions of the thermostat may include increasing or decreasing the set temperature, activating or changing the current HVAC system in use (e.g., heating, cooling), changing a feature of the schedule of the thermostat, or other thermostat operations.

The additional device 109, in one example, may include an aroma diffuser. An aroma diffuser may include a device that heats aromatic oils to cause them to evaporate and diffuse into the air. The aroma diffuser may be an IoT device. Predetermined actions of the aroma diffuser may include activating or deactivating the diffuser or increasing or decreasing a heat setting of the diffuser.

The additional device 109 may include a humidifier or a dehumidifier. A humidifier may include a device configured to cause the evaporation of liquid water in order to increase the humidity of a surrounding environment. A dehumidifier may include a device configured to remove water vapor from the surrounding environment in order to decrease the humidity. Predetermined actions for the humidifier or dehumidifier may include activating or deactivating the humidifier/dehumidifier or increasing or decreasing the humidification/dehumidification rate. The additional device 109 may include some other type of device that can be connected to a client device 102A-N, 104 or connected to the network 150 and that is configured to obtain data and perform predetermined actions based on the obtained data.

In some implementations, the additional device 109 can be connected to an associated client device 102A-N, 104. For example, the additional device 109 can be connected to the client device 102A-N, 104 via a Universal Serial Bus (USB) cable or some other physical cable. The additional device 109 can be connected to the client device 102A-N, 104 over a wireless connection (e.g., Bluetooth). In some implementations, the additional device 109 may not be connected to a client device 102A-N, 104 but can be connected to the network 150 (e.g., as discussed above, the additional device 109 may be an IoT device).

In one or more implementations, some or all components of the additional devices manager 138 can be part of a client device 102A-N, 104. For example, the application 105A-N can include the additional devices manager 138. In some implementations, the application 105A sends the video stream to the other client devices 102B-N, 104, and receives the video streams from the other client devices 102B-N, 104, and the applications 105A-105N can generate their respective virtual meeting UIs 108A-N or can finalize their respective UIs 108A-N, which may have been partially generated by the UI controller 136.

In some implementations, the data store 140 is a persistent storage that is capable of storing data as well as data structures to tag, organize, and index the data. A data item can include audio data and/or video stream data, in accordance with implementations described herein. The data store 140 can be hosted by one or more storage devices, such as main memory, magnetic or optical storage-based disks, tapes, hard drives, flash memory, and so forth. In some implementations, the data store 140 is a network-attached file server, while in other implementations, the data store 140 is some other type of persistent storage such as an object-oriented database, a relational database, and so forth, that can be hosted by the virtual meeting platform 120 or one or more different machines (e.g., the server 130) coupled to the virtual meeting platform 120 using the network 150. In some implementations, the data store 140 stores portions of audio and video streams received from one or more client devices 102A-N, 104 for the virtual meeting platform 120. Moreover, the data store 140 can store various types of documents, such as a slide presentation, a text document, a spreadsheet, or any suitable electronic document (e.g., an electronic document including text, tables, videos, images, graphs, slides, charts, software programming code, designs, lists, plans, blueprints, maps, etc.). These documents can be shared with users of the client devices 102A-N, 104 and/or concurrently editable by the users.

In some implementations, the network 150 includes a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

It should be noted that in some implementations, the functions of the virtual meeting platform 120 or the server 130 are provided by a fewer number of machines. For example, in some implementations, the server 130 is integrated into a single machine, while in other implementations, the server 130 is integrated into multiple machines. In addition, in one or more implementations, the server 130 is integrated into the virtual meeting platform 120.

In general, one or more functions described in the several implementations as being performed by the virtual meeting platform 120 or server 130 can also be performed by the client devices 102A-N, 104 in other implementations, if appropriate. In addition, in some implementations, the functionality attributed to a particular component can be performed by different or multiple components operating together. The virtual meeting platform 120 or the server 130 can also be accessed as a service provided to other systems or devices through appropriate application programming interfaces, and thus is not limited to use in websites.

Although implementations of the disclosure are discussed in terms of the virtual meeting platform 120 and users of the virtual meeting platform 120 participating in a virtual meeting 122, implementations can also be generally applied to any type of telephone call, conference call, or other technological communications methods between users. Implementations of the disclosure are not limited to virtual meeting platforms that provide virtual meeting tools to users.

FIG. 2 illustrates an example AI training subsystem 200 that can be used to train the AI model 232A-M, in accordance with implementations of the present disclosure. As illustrated in FIG. 2, the AI training subsystem 200 can include a training subsystem 210, which may include a training data engine 212, a training engine 214, a validation engine 216, a selection engine 218, or a testing engine 220. The AI training subsystem 200 may include one or more AI models 232A-M.

In one implementation, an AI model 232A-M includes one or more of artificial neural networks (ANNs), decision trees, random forests, support vector machines (SVMs), clustering-based models, Bayesian networks, or other types of machine learning models. ANNs generally include a feature representation component with a classifier or regression layers that map features to a target output space. The ANN can include multiple nodes (“neurons”) arranged in one or more layers, and a neuron may be connected to one or more neurons via one or more edges (“synapses”). The synapses can perpetuate a signal from one neuron to another, and a weight, bias, or other configuration of a neuron or synapse can adjust a value of the signal. Training the ANN may include adjusting the weights or other features of the ANN based on an output produced by the ANN during training.

An ANN may include, for example, a convolutional neural network (CNN), recurrent neural network (RNN), or a deep neural network. A CNN, a specific type of ANN, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g., classification outputs). A deep network may include an ANN with multiple hidden layers or a shallow network with zero or a few (e.g., 1-2) hidden layers. Deep learning is a class of machine learning algorithms that use a cascade of multiple layers of nonlinear processing units for feature extraction and transformation. Each successive layer uses the output from the previous layer as input. An RNN is a type of ANN that includes a memory to enable the ANN to capture temporal dependencies. An RNN is able to learn input-output mappings that depend on both a current input and past inputs. The RNN will address past and future measurements and make predictions based on this continuous measurement information. One type of RNN that can be used is a long short term memory (LSTM) neural network.

ANNs can learn in a supervised (e.g., classification) or unsupervised (e.g., pattern analysis) manner. Some ANNs (e.g., such as deep neural networks) may include a hierarchy of layers, where the different layers learn different levels of representations that correspond to different levels of abstraction. In deep learning, each level learns to transform its input data into a slightly more abstract and composite representation.

In one implementation, an AI model 232A-M includes a generative AI model. A generative AI model can deviate from a machine learning model based on the generative AI model's ability to generate new, original data, rather than making predictions based on existing data patterns. A generative AI model can include a generative adversarial network (GAN), a variational autoencoder (VAE), a large language model (LLM), or a diffusion model. In some instances, a generative AI model can employ a different approach to training or learning the underlying probability distribution of training data, compared to some machine learning models. For instance, a GAN can include a generator network and a discriminator network. The generator network attempts to produce synthetic data samples that are indistinguishable from real data, while the discriminator network seeks to correctly classify between real and fake samples. Through this iterative adversarial process, the generator network can gradually improve its ability to generate increasingly realistic and diverse data.

Generative AI models also have the ability to capture and learn complex, high-dimensional structures of data. One aim of generative AI models is to model underlying data distribution, allowing them to generate new data points that possess the same characteristics as training data. Some machine learning models (e.g., that are not generative AI models) focus on optimizing specific prediction of tasks.

In some implementations, an AI model 232A-M is an AI model that has been trained on a corpus of data. For example, the AI model 232A-M can be an AI model that is first pre-trained on a corpus of data to create a foundational model, and afterwards fine-tuned on more data pertaining to a particular set of tasks to create a more task-specific, or targeted, model. The foundational model can first be pre-trained using a corpus of data that can include data in the public domain, licensed content, and/or proprietary content. Such a pre-training can be used by the AI model 232A-M to learn broad elements including, image or speech recognition, general sentence structure, common phrases, vocabulary, natural language structure, and other elements. In some implementations, this first foundational model is trained using self-supervision, or unsupervised training on such datasets.

In some implementations, the second portion of training, including fine-tuning, includes unsupervised, supervised, reinforced, or any other type of training. In some implementations, this second portion of training includes some elements of supervision, including learning techniques incorporating human or machine-generated feedback, undergoing training according to a set of guidelines, or training on a previously labeled set of data, etc. In a non-limiting example associated with reinforcement learning, the outputs of the AI model 232A-M while training may be ranked by a user, according to a variety of factors, including accuracy, helpfulness, veracity, acceptability, or any other metric useful in the fine-tuning portion of training. In this manner, the AI model 232A-M can learn to favor these and any other factors relevant to users when generating a response. Further details regarding training are provided below.

In some implementations, an AI model 232A-M includes one or more pre-trained models, or fine-tuned models. In a non-limiting example, in some implementations, the goal of the “fine-tuning” can be accomplished with a second, or third, or any number of additional models. For example, the outputs of the pre-trained model can be input into a second AI model that has been trained in a similar manner as the “fine-tuned” portion of training above. In such a way, two more AI models 232A-M can accomplish work similar to one model that has been pre-trained, and then fine-tuned.

As indicated above, an AI model 232A-M can be one or more generative AI models, allowing for the generation of new and original content. In one implementation, a generative AI model includes a diffusion model. A diffusion model may include a deep generative model that can be used to generate images, edit existing images, and create new image styles. The diffusion model may have been trained by iteratively applying a diffusion process to an input image, which may include gradually adding noise to the image until it becomes unrecognizable. The diffusion model then learns to reverse this process, starting from the noisy image and gradually denoising it until it becomes a recognizable image. In some implementations, the diffusion model may have been trained on multiple virtual meeting backgrounds by using different virtual meeting backgrounds as input images during the training process.

In one implementation, the training subsystem 210 manages the training and testing of an AI model 232A-M. The training data engine 212 can generate training data (e.g., a set of training inputs such as noisy virtual meeting background images and a set of target outputs such as respective denoised virtual meeting background images) to train an AI model 232A-M. In an illustrative example, the training data engine 212 can initialize a training set T to null (e.g., { }). The training data engine 212 can add the training data to the training set T and can determine whether training set T is sufficient for training a AI model 232A-M. The training set T can be sufficient for training the AI model 232A-M if the training set T includes a threshold amount of training data, in some implementations. In response to determining that the training set T is not sufficient for training, the training data engine 212 can identify additional data to use as training data. In response to determining that the training set T is sufficient for training, the training data engine 212 can provide the training set T to the training engine 214.

In some implementations, the training data includes an image as a training input. The training data including an image may include the training data including an embedding generated from the image. The image may include an image of an additional device 109. The training data may include, as a corresponding target output, data identifying the additional device 109 of the training input image. The data identifying the additional device 109 may include a name, model number, or original equipment manufacturer (OEM) identifier of the additional device 109. The data identifying the additional device 109 may include other data that may be associated with the additional device 109.

The training engine 214 can train an AI model 232A-M using the training data (e.g., training set T). The AI model 232A-M may refer to the model artifact that is created by the training engine 214 using the training data, where such training data can include training inputs and, in some implementations, corresponding target outputs. The training engine 214 can input the training data into the AI model 232A-M so that the AI model 232A-M can find patterns in the training data and configure itself based on those patterns.

Where the AI model 232A-M uses supervised learning, the training engine 214 can assist the AI model 232A-M in determining whether the AI model 232A-M maps the training input to the target output. Where the AI model 232A-M uses unsupervised learning, the training engine 214 can input the training data into the AI model 232A-M The AI model 232A-M can configure itself based on the input training data, but since the training data may not include a target output, the training engine 214 may not assist the AI model 232A-M in determining whether the AI model 232A-M provided a correct output during the training process.

The validation engine 216 may be capable of validating a trained AI model 232A-M using a corresponding set of features of a validation set from the training data engine 212. The validation engine 216 can determine an accuracy of each of the trained AI models 232A-M based on the corresponding sets of features of the validation set. Where the training data may not include a target output, validating a trained AI model 232A-M may include obtaining an output from the AI model 232A-M and providing the output to another entity for evaluation. The other entity may include another AI model configured to evaluate the output of the AI model 232A-M that is undergoing training. The other entity may include a human. The validation engine 216 can discard a trained AI model 232A-M that has an accuracy that does not meet a threshold accuracy or that otherwise fails evaluation. In some implementations, the selection engine 218 is capable of selecting a trained AI model 232A-M that has an accuracy that meets a threshold accuracy. In some implementations, the selection engine 218 may be capable of selecting the trained AI model 232A-M that has the highest accuracy of multiple trained AI models 232A-M. In some implementations, the selection engine 218 receives input from another AI model or a human and can select a trained AI model 232A-M based on the input.

The testing engine 220 may be capable of testing a trained AI model 232A-M using a corresponding set of features of a testing set from the training data engine 212. For example, a first trained AI model 232A that was trained using a first set of features of the training set may be tested using the first set of features of the testing set. The testing engine 220 can determine a trained AI model 232A-M that has the highest accuracy or other evaluation of all of the trained AI models 232A-M based on the testing sets.

In one implementation, the training engine 214 trains an AI model 232A. The training data engine 212 can generate training data that includes images of virtual meeting backgrounds, and the training engine 214 can cause the AI model 232A to undergo a diffusion model training process using the training data. The AI model 232A can undergo a validation and testing process using the validation engine 216 and testing engine 220.

In some implementations, the AI training subsystem 300 is part of the server 130, the virtual meeting manager 132, or the additional devices manager 138. Alternatively, the AI training subsystem 200 may be part of another server, system, sub-system, or it may be an independent system. In some implementations, the AI training subsystem 200 provides the trained one or more AI models 232A-M to the additional devices manager 138.

FIG. 3 illustrates an example AI inference subsystem 139 that the additional devices manager 138 can use to perform one or more operations, in accordance with implementations of the present disclosure. The AI inference subsystem 139 may include an AI model subsystem 230, which may include one or more AI models 232A-M. The one or more AI models 232A-M may include one or more of the AI models 232A-M trained by the AI training subsystem 200.

In some implementations, the AI inference subsystem 139 includes an AI input/output component 310. The AI input/output component 310 can be configured to feed data as input to an AI model 232A-M, e.g., from the additional devices manager 138. The AI input/output component 310 can be configured to obtain one or more outputs from the one or more AI models 232A-M and provide the one or more outputs to the additional devices manager 138.

In one implementation, the additional devices manager 138 can provide one or more images from a video stream produced by a client device 102A-N, 104, as input to the AI input/output component 310. The AI input/output component 310 can provide the image(s) to the AI model 232A-M, which can process the input and generate an output. The output may include data identifying one or more additional devices 109 present in the input image(s). The AI input/output component 310 can provide the output to the additional devices manager 138. The additional devices manager 138 can use the data identifying the one or more additional devices 109 to request that the participant using the client device 102A-N, 104 make the one or more additional devices 109 available to other participants of the virtual meeting 122.

FIG. 4 is a flowchart illustrating one embodiment of a method 400 for providing data to additional devices 109 in a virtual meeting, in accordance with some implementations of the present disclosure. A processing device, having one or more central processing units (CPU(s)), one or more graphics processing units (GPU(s)), and/or memory devices communicatively coupled to the one or more CPU(s) and/or GPU(s) can perform the method 400 and/or one or more of the method's 400 individual functions, routines, subroutines, or operations. In certain implementations, a single processing thread can perform the method 400. Alternatively, two or more processing threads can perform the method 400, each thread executing one or more individual functions, routines, subroutines, or operations of the method. In an illustrative example, the processing threads implementing the method 400 can be synchronized (e.g., using semaphores, critical sections, and/or other thread synchronization mechanisms). Alternatively, the processing threads implementing the method 400 can be executed asynchronously with respect to each other. Various operations of the method 400 can be performed in a different (e.g., reversed) order compared with the order shown in FIG. 4. Some operations of the method 400 can be performed concurrently with other operations. Some operations can be optional. In some implementations, the additional devices manager 138 performs one or more of the operations of the method 400.

At block 410, processing logic causes a virtual meeting UI 108A-N to be presented during a virtual meeting 122 between one or more participants. The virtual meeting UI 108A-N may include one or more regions. Each region can correspond to a media stream generated by a client device 102A-N, 104 of a participant of the one or more participants.

As discussed above, a region may include a visual item, which may include a video stream. A region can present the video stream of the media stream generated by the client device 102A-N, 104 that corresponds to the region. The video stream may include one or more images (e.g., video frames) captured by a camera associated with the corresponding client device 102A-N, 104. The video stream may depict the participant associated with the client device 102A-N, 104. The video stream may depict one or more additional devices 109 in an environment of the associated participant. In some embodiments, the one or more additional devices 109 may not be depicted in the video stream but may be otherwise associated with the client device that generates the video stream due its proximity or connection with the client device 102A-N, 104, as can be reflected in a data store (e.g., data store 140) that contains information about the client devices 102A-N, 104 and that is accessible to the additional device manager 138.

At block 420, processing logic obtains an indication that a first additional device 109 associated with a first client device 102A of a first participant of the one or more participants is available at a location of the first participant. The indication that the first additional device 109 is available may include data identifying the additional device 109 (e.g., a device name, a device model identifier, etc., data identifying the type of the additional device (e.g., printer, mobile device, VR headset, etc.)). In some implementations, the additional devices manager 138 may obtain the indication that the first additional device 109 is available from the first client device 102A. For example, the application 105A may obtain a list of additional devices 109 associated with the first client device 102A from a device manager or other similar application of the operating system of the first client device 102A. In another example, the first participant may provide user input to the application 105A via the virtual meeting UI 108A, and the application 105A may generate the indication based on the user input.

In one implementation, the additional devices manager 138 may obtain data identifying one or more predetermined actions the additional device 109 can perform (e.g., printing, receiving a computer file, executing a mobile application, displaying a video, etc.). In some implementations, the data identifying the one or more predetermined actions is obtained by the additional devices manager 138 from the client device 102A (e.g., via user input by the first participant) or from a data store (e.g., the data store 140). For example, the additional devices manager 138 may use the data identifying the additional device 109 to look up the one or more predetermined actions in the data store 140. In one implementation, the data identifying one or more predetermined actions the additional device 109 can perform may be included in the indication that the first additional device 109 is available.

The first participant may not want to make all of the predetermined actions of the first additional device 109 to be available to other participants of a virtual meeting 122. For example, the first participant can allow other participants to provide files to a mobile device, but the first participant may not allow other participants to cause the mobile device to play video or audio data. In some implementations, the additional devices manager 138 may obtain, from the first client device 102A, an indication identifying one or more predetermined actions that are available to other participants and identifying which predetermined actions are not available to other participants. In one implementation, the virtual meeting UI 108A of the first client device 102A may include one or more UI elements (e.g., a menu option) that present one or more options for the first participant to provide input to the application 105A, and the input may indicate which predetermined actions are available to other participants and which predetermined actions are not available to other participants. The application 105A can provide data based on the input to the additional devices manager 138, and the additional devices manager 138 can provide data indicating the availability of predetermined actions to other client devices 102B-N, 104.

The first participant can make the first additional device 109 available to other participants for a portion of the virtual meeting 122 (and not during the entire virtual meeting 122). In some implementations, the indication that the first additional device 109 is available at the location of the first participant further includes an amount of time during the virtual meeting 122 that the first additional device 109 is available to receive first data from a second participant. The amount of time may include a length of time, a time period during the virtual meeting 122 (e.g., the first 20 minutes of the virtual meeting 122), or other time-based availability data.

At block 430, processing logic causes the virtual meeting UI 108A-N to be modified to present, in a first region corresponding to a first media stream generated by the first client device 102A, a visual indication of the first additional device 109. The visual indication can alert other virtual meeting participants of the availability of the first additional device 109 to perform one or more predetermined actions during the virtual meeting 122. In some implementations, the additional devices manager 138 can provide data to the UI controller 136 indicating the first additional device 109 and the one or more predetermined actions available to participants of the virtual meeting 122. The UI controller 136 can use the data to modify the virtual meeting UI 108A-N to present the visual indication of the first additional device 109.

In one implementation, the visual indication of the first additional device 109 includes an outline of the first additional device 109 overlayed on the first additional device 109 presented in the first region. The outline of the first additional device 109 may include a line that traces the shape of the first additional device 109. The outline may include a color that contrasts with the first additional device 109 or the area around the first additional device 109 to assist participants in locating the first additional device 109 in the first region of the UI 108A-N. In some implementations, the visual indication includes an image overlayed on the depiction of the first additional device 109 in the first region.

In one or more implementations, a participant can interact with the visual indication for the first additional device 109 presented in the first region of the virtual meeting UI 108A-N. For example, the participant can click on the visual indication for the first additional device 109 in the first region or tap the area of a touchscreen that is presenting the first additional device 109 in the first region. Responsive to the participant interacting with visual indication for the first additional device 109 in the first region, the virtual meeting UI 108A-N can present one or more UI elements that present one or more options that indicate the one or more predetermined actions associated with the first additional device 109 that are available to the participant. For example, responsive to a second participant clicking on a visual indication for a printer, the virtual meeting UI 108B of the second participant can present a UI element that includes a file selector that accepts a file stored on the second participant's client device 102B so the additional devices manager 138 can provide the file to the printer.

In one or more implementations, the one or more UI elements that present one or more options indicating the one or more predetermined actions include text indicating the respective one or more predetermined actions. The one or more UI elements may include a UI element that allows the second participant to specify data to send to the additional device 109. The data may include a file stored on the second participant's client device 102B or data stored on another device (e.g., a cloud-based data storage platform).

Responsive to the second participant selecting a UI element (which may include the second participant selecting a file to provide, or indicating data stored on another device to provide, to the first additional device 109), the application 105B can provide data indicating the selection and/or the provided file or data, to the additional devices manager 138.

At block 440, processing logic causes first data indicated by a second client device 102B of a second participant of the one or more participants to be sent to the first additional device 109. The first data can, at least in part, cause the first additional device 109 to perform a first predetermined action. In some implementations, the additional devices manager 138 can provide the first data to the first additional device 109 or can cause the first data to be provided to the first additional device 109 (e.g., via the first client device 102A).

In one implementation, the first data may include data indicating the first predetermined action for the first additional device 109 to perform. The first data may include a file from the second client device 102B to be provided to the first additional device 109, which the first additional device 109 can use to perform the first predetermined action. The first data may include an indication of data stored externally from the second client device 102B, which the first additional device 109 can receive and use to perform the first determined action.

In one implementation, causing the first data to be sent to the first additional device 109 includes causing a file to be provided to the first additional device 109. The file may include a file stored on the second client device 102B or a file stored externally from the second client device 102B. The additional devices manager 138 can obtain the file over the network 150 and provide the file to the first additional device 109. In some implementations, causing the first data to be sent to the first additional device 109 includes causing the file to be provided to the first client device 102A of the first participant. The first client device 102A may be in data communication with the first additional device 109 (e.g., via a USB cable or over a wireless connection), and the first client device 102A can send the file to the first additional device 109.

In one or more implementations, causing the first data to be sent to the first additional device 109 includes causing an IoT request to be provided to the first additional device 109. The IoT request may include data indicating the first predetermined action to be performed by the first additional device 109. The IoT request may include data (e.g., a file) that the first additional device 109 can use to perform the first predetermined action.

In one implementation, the first additional device 109 includes a printer. The first data may include a printable file. The first predetermined action may include printing the printable file. The first predetermined action may include other actions performable by a printer or a multifunction printer, as discussed above. In one implementation, the first additional device includes a lighting device. The first data may include a command to the lighting device. The first predetermined action may include the lighting device performing a lighting action based on the command.

In some implementations, the first additional device 109 includes a VR headset. The first data may include a file that includes data that is displayable using the VR headset, and the first predetermined action may include displaying data from the file. The first data may include video data, and the first predetermined action may include playing the video data on the VR headset. The first data may include a VR application that can provide visuals to the VR headset, and the first predetermined data may include executing the VR application. The first data and the first predetermined action may include other types of data or actions associated with a VR headset, as discussed above.

In one or more implementations, the first additional device 109 includes an audio speaker. The first data may include audio data, and the first predetermined action may include playing the audio data. The first data may include a volume change command, and the first predetermined action may include changing the volume of the audio speaker. The first data may include a command for the virtual assistant of the audio speaker, and the first predetermined action may include performing the command. The first additional device 109, the first data, and the first predetermined action may include other types of devices, data and actions described in this disclosure.

In some implementations, the second participant can cause the first data to be provided to the first additional device 109 so the first additional device 109 of the first participant and a second additional device 109 of the second participant can perform the first predetermined action in a synchronized manner. The additional devices manager 138 can cause the first data to be provided to a second additional device 109. The second additional device 109 may include an additional device 109 of the second participant. The additional devices manager 138 can cause the second additional device 109 to perform the first predetermined action in a synchronized manner with the first additional device 109. As an example, the first additional device 109 may include the first participant's mobile device, the second additional device 109 may include the second participant's mobile device, the first data may include a video file, and the first predetermined action may include playing the video file. The additional devices manager 138 can cause the first data to be provided to the first and second additional devices 109 and can cause the first and second additional devices 109 to play the video file at the same time so the first and second participants can watch the video file at the same time.

In some implementations, the first participant may not use the application 105A to make an additional device 109 available to other virtual meeting participants (e.g., the first participant may forget to make the additional device 109 available). The additional devices manager 138 can identify one or more additional devices 109 in the first participant's video stream and request that the first participant makes the one or more additional devices 109 available. In one implementation, the additional devices manager 138 identifies, using an AI model 232A-M, a second additional device 109 present in the first region. The additional devices manager 138 can use a representation of the first region as input to the AI model 232A-M. The representation of the first region may include a frame of the video stream presented in the first region. The additional devices manager 138 can provide the representation of the first region to the AI inference subsystem 139, which can use the AI model 232A-M to identify one or more additional devices 109 present in the representation of the first region, as discussed above. The additional devices manager 138 can provide a request, presentable on the first client device 102A of the first participant, to make the second additional device 109 available to receive data.

In one example, the additional devices manager 138 can provide a UI element to the virtual meeting UI 108A of the first client device 102A, and the UI element may include a request to make the second additional device 109 available. In another example, the additional devices manager 138 can provide a UI element to the virtual meeting UI 108B of the second client device 102B of a second virtual meeting participant, and the UI element can indicate that a second additional device 109 associated with the first participant has been detected and that the second participant can request that the first participant make the second additional device 109 available.

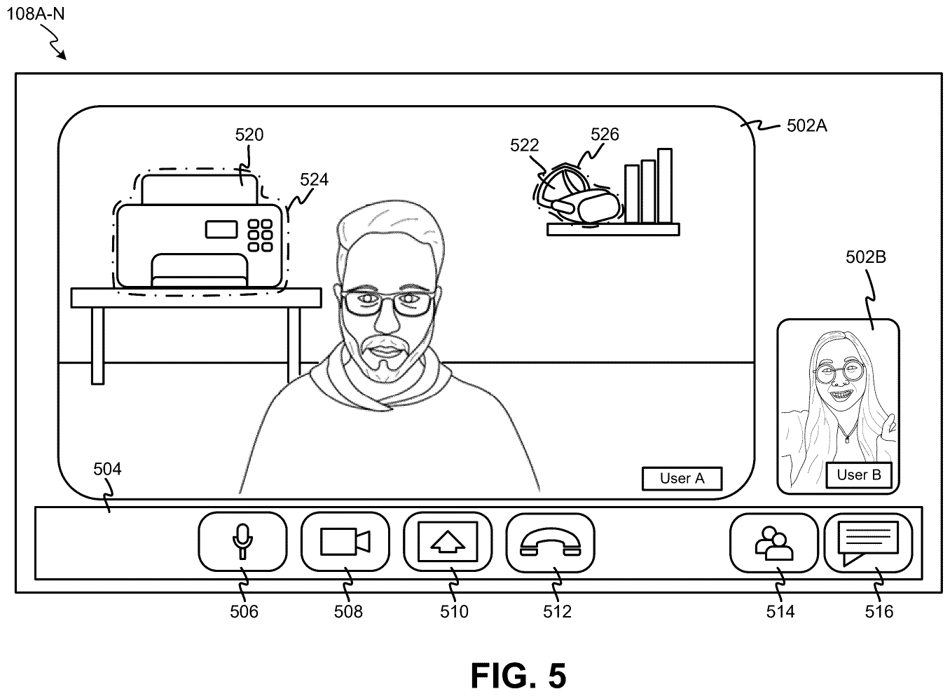

FIG. 5 depicts a virtual meeting UI 108A-N for a virtual meeting 122, in accordance with some implementations of the present disclosure. The virtual meeting UI 108A-N may include one or more regions 502A-B corresponding to a visual item of the virtual meeting 122, such as a video stream provided by a client device 102A-N of a participant of the virtual meeting 122. The virtual meeting UI 108A-N can include a toolbar 504 that includes one or more UI elements configured to perform virtual meeting operations. For example, as seen in FIG. 5, the toolbar 504 includes an audio control button 506 used to mute and unmute a participant's audio stream, a camera control button 508 used to mute and unmute a participant's video stream, a screen share button 510 used to share a participant's client device's 102A-N screen with other participants of the virtual meeting 122, and a disconnect button 512 used to leave or disconnect from the virtual meeting 122. The toolbar 504 may include a participants button 514 that can display a list of the one or more participants of the virtual meeting 122. The toolbar 504 may include a chat button 516 that can display a chat interface that allows participants of the virtual meeting 122 to send and receive chat messages in the virtual meeting 122.

The video stream represented in the first region 502A may include a printer 520 as a first additional device 109. The video stream may include a VR headset 522 as a second additional device 109. The first region 502A may include a first outline 524 overlayed on the printer 520 to indicate that the printer 520 is an additional device 109 that is available to receive data and perform predetermined actions. The first region 502A may include a second outline 526 overlayed on the VR headset 522.

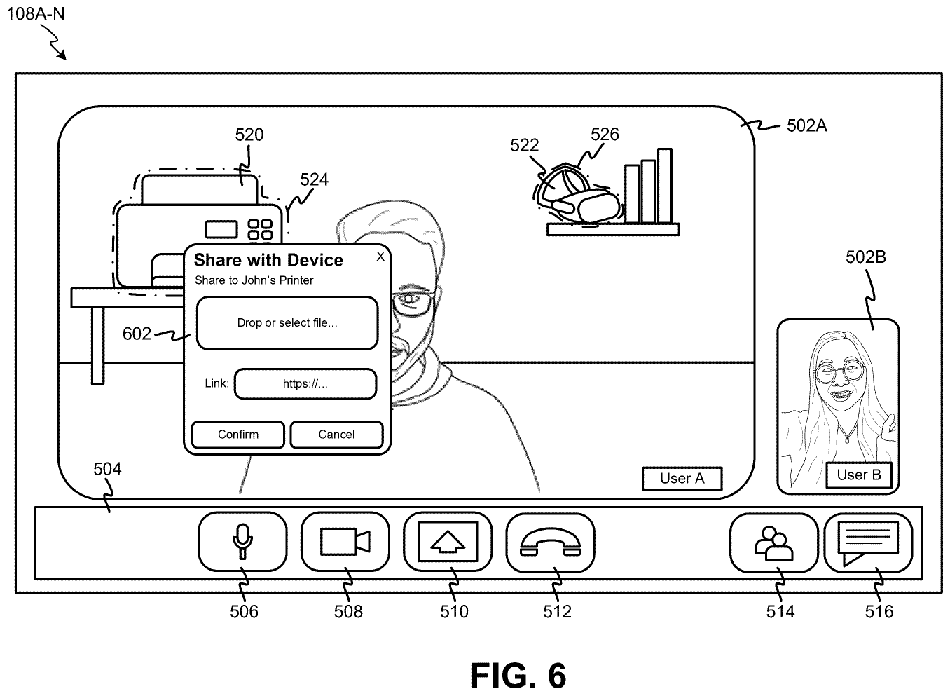

FIG. 6 depicts another example of the virtual meeting UI 108A-N for a virtual meeting 122, in accordance with some implementations of the present disclosure. In response to a second participant interacting with the location in the first region 502A corresponding to the printer 520 (e.g., the second participant clicking on the printer 520 in the first region 502A), the virtual meeting UI 108A-N can present a UI element 602. As seen in FIG. 6, the UI element 602 may include an area for the second participant to provide a file stored on the second client device 102B of the second participant. The UI element 602 may include a text box where the second participant can provide data indicating a location of a file stored externally from the second client device 102B. The UI element 602 may include a button that the second participant can interact with to confirm that the second participant wants to send the provided file or data indicating the file to the additional devices manager 138 so the file can be provided to the printer 520.

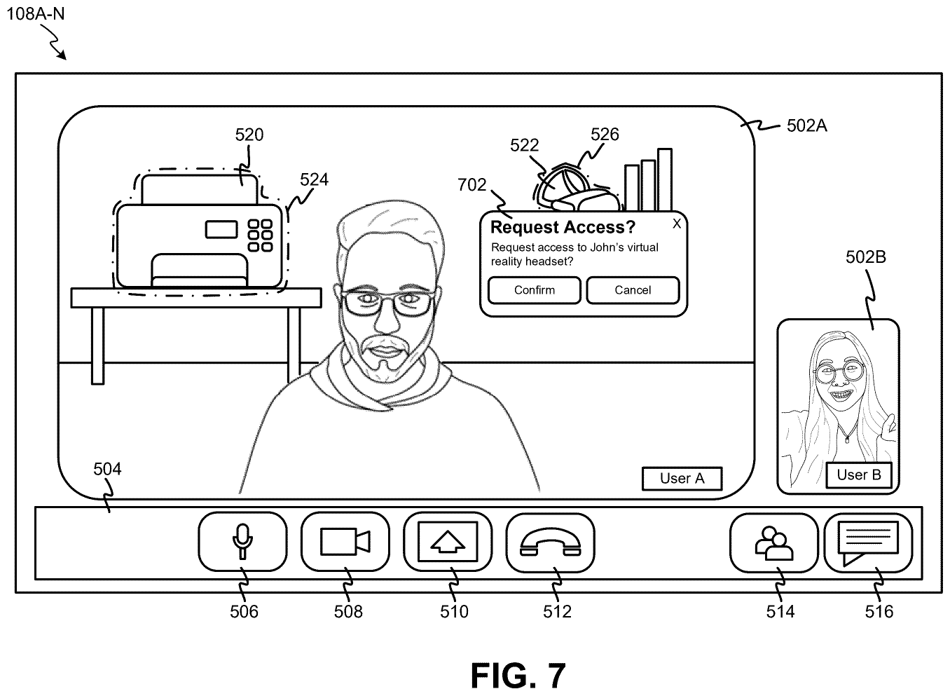

FIG. 7 depicts another example of the virtual meeting UI 108A-N for a virtual meeting 122, in accordance with some implementations of the present disclosure. In response to a second participant interacting with the location in the first region 502A corresponding to the VR headset 522 (e.g., the second participant clicking on the VR headset 522 in the first region 502A), the virtual meeting UI 108A-N can present a UI element 702. As seen in FIG. 7, the UI element 702 may include a message indicating that the first participant has not made the VR headset 522 available to receive data or perform predetermined actions. The UI element 702 may include a message asking if the second participant would like to send a request to the first participant to make the VR headset 522 available. Responsive to the second participant confirming to send the request, the additional devices manager 138 can send a request to the first participant's client device 102A to make the VR headset 522 available.

In some implementations, the outline 526 of the VR headset 522 may be visually different from the outline 524 of the printer 520 to indicate to the second participant that the first participant has not made the VR headset 522 available. The visual indication of an unavailable additional device 109 may include a different color or a different image than those of an available additional device 109.

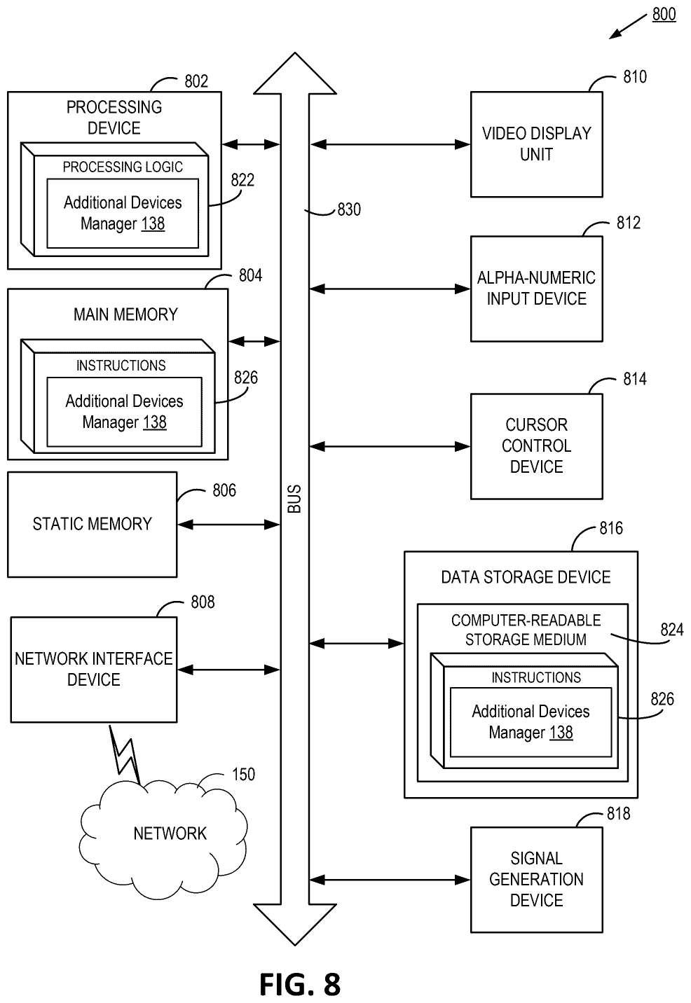

FIG. 8 is a block diagram illustrating an example computer system, in accordance with implementations of the present disclosure. The computer system 800 can include a client device 102A-N, 104, the virtual meeting platform 120, or the server 130 in FIG. 1. The machine can operate in the capacity of a server or an endpoint machine, in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processing device (processor) 802, a main memory 804 (e.g., read-only memory (ROM), flash memory, dynamic random access memory (DRAM) such as synchronous DRAM (SDRAM), double data rate (DDR SDRAM), or DRAM (RDRAM), etc.), a static memory 806 (e.g., flash memory, static random access memory (SRAM), etc.), and a data storage device 816, which communicate with each other via a bus 830.

The processing device 802 represents one or more general-purpose processing devices such as a microprocessor, central processing unit, or the like. More particularly, the processing device 802 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 802 can also be one or more special-purpose processing devices such as an application specific integrated circuit (ASIC), a field programmable gate array (FPGA), a digital signal processor (DSP), network processor, or the like. The processing device 802 is configured to execute the processing logic 822 for performing the operations discussed herein (e.g., the operations of the additional devices manager 138).

The computer system 800 can further include a network interface device 808. The computer system 800 also can include a video display unit 810 (e.g., a liquid crystal display (LCD) or a cathode ray tube (CRT)), an input device 812 (e.g., a keyboard, and alphanumeric keyboard, a motion sensing input device, touch screen), a cursor control device 814 (e.g., a mouse), and a signal generation device 818 (e.g., a speaker).

The data storage device 816 can include a non-transitory machine-readable storage medium 824 (sometimes referred to as a “computer-readable storage medium”) on which is stored one or more sets of instructions 826 (e.g., the instructions to carry out one or more operations of the additional devices manager 138) embodying any one or more of the methodologies or functions described herein. The instructions can also reside, completely or at least partially, within the main memory 804 and/or within the processing device 802 during execution thereof by the computer system 800, the main memory 804 and the processing device 802 also constituting machine-readable storage media. The instructions can further be transmitted or received over the network 150 via the network interface device 808.

In one implementation, the instructions 826 include instructions for determining visual items for presentation in a user interface of a virtual meeting. While the computer-readable storage medium 824 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” or “an implementation,” means that a particular feature, structure, or characteristic described in connection with the implementation is included in at least one implementation. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interaction between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or. ” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A method, comprising:
causing a virtual meeting user interface (UI) to be presented during a virtual meeting between a plurality of participants, the virtual meeting UI comprising a plurality of regions each corresponding to a media stream generated by a client device of a participant of the plurality of participants;
obtaining an indication that a first additional device associated with a first client device of a first participant of the plurality of participants is available at a location of the first participant;
causing the virtual meeting UI to be modified to present, in a first region of the plurality of regions corresponding to a first media stream generated by the first client device, a visual indication of the first additional device; and
causing first data indicated by a second client device of a second participant of the plurality of participants to be sent to the first additional device to cause the first additional device to perform a first predetermined action.

2. The method of claim 1, wherein:
the first additional device comprises a printer;
the first data comprises a printable file; and
the first predetermined action comprises printing the printable file.

3. The method of claim 1, wherein:
the first additional device comprises a virtual reality (VR) headset;
the first data comprises a file displayable using the VR headset; and
the first predetermined action comprises displaying data from the file.

4. The method of claim 1, wherein:
the first additional device comprises a VR headset;
the first data comprises video data; and
the first predetermined action comprises playing the video data.

5. The method of claim 1, wherein the indication that the first additional device is available at the location of the first participant further comprises at least one of:
an amount of time during the virtual meeting that the first additional device is available to receive the first data; or
an indication identifying a plurality of predetermined actions, wherein the plurality of predetermined actions comprises the first predetermined action.

6. The method of claim 1, wherein causing the first data to be sent to the first additional device comprises at least one of:
causing an Internet of things (IoT) request to be provided to the first additional device; or
causing a file to be provided to the first client device of the first participant, wherein the first client device is in data communication with the first additional device.

7. The method of claim 1, wherein the visual indication comprises an outline of the first additional device overlayed on the first additional device presented in the first region.

8. The method of claim 1, further comprising:
causing the first data to be provided to a second additional device of the second participant; and
causing the second additional device to perform the first predetermined action in a synchronized manner with the first additional device.

9. A system, comprising:
a memory; and
a processing device, coupled with the memory, configured to perform operations comprising:
causing a virtual meeting user interface (UI) to be presented during a virtual meeting between a plurality of participants, the virtual meeting UI comprising a plurality of regions each corresponding to a media stream generated by a client device of a participant of the plurality of participants,
obtaining an indication that a first additional device associated with a first client device of a first participant of the plurality of participants is available at a location of the first participant,
causing the virtual meeting UI to be modified to present, in a first region of the plurality of regions corresponding to a first media stream generated by the first client device, a visual indication of the first additional device, and
causing first data indicated by a second client device of a second participant of the plurality of participants to be sent to the first additional device to cause the first additional device to perform a first predetermined action.

10. The system of claim 9, wherein:
the first additional device comprises a lighting device;
the first data comprises a command to the lighting device; and
the first predetermined action comprises performing a lighting action based on the command.

11. The system of claim 9, wherein:
the first additional device is an audio speaker;
the first data comprises audio data; and
the first predetermined action comprises playing the audio data.

12. The system of claim 9, wherein:
the first additional device is an audio speaker;
the first data comprises a volume change command; and
the first predetermined action comprises changing a volume of the audio speaker.

13. The system of claim 9, further comprising:
identifying, using an artificial intelligence (AI) model and using a representation of the first region as input to the AI model, a second additional device present in the first region; and
providing a request, presentable on the first client device of the first participant, to make the second additional device available to receive data.

14. The system of claim 9, wherein the visual indication comprises an outline of the first additional device overlayed on the first additional device presented in the first region.

15. A non-transitory computer-readable storage medium with instructions, wherein the instructions, when executed by a processing device, cause the processing device to perform one or more operations, comprising:
causing a virtual meeting user interface (UI) to be presented during a virtual meeting between a plurality of participants, the virtual meeting UI comprising a plurality of regions each corresponding to a media stream generated by a client device of a participant of the plurality of participants;
obtaining an indication that a first additional device associated with a first client device of a first participant of the plurality of participants is available at a location of the first participant;
causing the virtual meeting UI to be modified to present, in a first region of the plurality of regions corresponding to a first media stream generated by the first client device, a visual indication of the first additional device; and
causing first data indicated by a second client device of a second participant of the plurality of participants to be sent to the first additional device to cause the first additional device to perform a first predetermined action.

16. The computer-readable storage medium of claim 15, wherein:
the first additional device comprises a printer;
the first data comprises a printable file; and
the first predetermined action comprises printing the printable file.

17. The computer-readable storage medium of claim 15, wherein:
the first additional device comprises a virtual reality (VR) headset;
the first data comprises a file displayable using the VR headset; and
the first predetermined action comprises displaying data from the file.

18. The computer-readable storage medium of claim 15, wherein causing the first data to be sent to the first additional device comprises at least one of:
causing an Internet of things (IoT) request to be provided to the first additional device; or
causing a file to be provided to the first client device of the first participant, wherein the first client device is in data communication with the first additional device.

19. The computer-readable storage medium of claim 15, wherein the visual indication comprises an outline of the first additional device overlayed on the additional device presented in the first region.

20. The computer-readable storage medium of claim 15, further comprising:
identifying, using an artificial intelligence (AI) model and using a representation of the first region as input to the AI model, a second additional device present in the first region; and
providing a request, presentable on the first client device of the first participant, to make the second additional device available to receive data.
